(19) United States
(12) Patent Application Publication
(10) Pub. No.: US 2018/0166909 A1
(43) Pub. Date: Jun. 14, 2018

(54) POWER SUPPLY SYSTEM

(71) Applicant: IPCORE LABORATORY INC., Tokyo (JP)

(72) Inventor: Masayuki SHINAGAWA, Tokyo (JP)

(73) Assignee: Ipcore Laboratory Inc., Tokyo (JP)

(21) Appl. No.: 15/570,025

(22) PCT Filed: Apr. 28, 2016
(86) PCT No.: PCT/JP2016/063368

§ 371 Date: Oct. 27, 2017

(30) Foreign Application Priority Data
Apr. 30, 2015 (JP) 2015-092823

(51) Int. Cl. H02J 7/34; G06F 1/26; H02J 7/00

(52) U.S. Cl. CPC H02J 7/34; G06F 1/263; H02J 3/381; H02J 7/345; H02J 7/0068

(57) ABSTRACT

A power supply system for ensuring stable operation of an electronic device such as ICT equipment or the like. The power supply system includes a wide-range DC/DC converter and a charge/discharge unit. The wide-range DC/DC converter outputs, upon input of a DC voltage within a predetermined voltage range, a voltage at one or more kinds of fixed value/values irrespective of the value of the input DC voltage to supply to the electronic device. The charge/discharge unit is connected to an external power source and the wide-range DC/DC converter, and charges/discharges depending on an increase/decrease of an output voltage of the external power source, to thereby stabilize power supplied to the wide-range DC/DC converter.

### CROSS-REFERENCE TO RELATED APPLICATIONS

This application is a U.S. National Stage Application, which claims the benefit under 35 U.S.C. § 371 of International Patent Application No. PCT/JP2016/063368, filed Apr. 28, 2016, which claims the foreign priority benefit under 35 U.S.C. § 119 of Japanese Patent Application No. 2015-092823, filed Apr. 30, 2015, the contents of which are incorporated herein by reference.

### TECHNICAL FIELD

The present invention relates to a power supply system for supplying power from an external power source to an electronic device such as ICT (Information and Communication Technology) equipment or the like.

### BACKGROUND ART

Most of the electronic devices of this type operate on a DC. Therefore, in order to cause such an electronic device to operate using a commercial AC power source, conventionally, a power supply system for connecting such an electronic device to the commercial power source via an AC adapter or a PSU (power supply unit) for converting an AC to a DC before supplying power has been widely used (see Japanese Patent Laid-open Publication No. 2008-228475, for example).

### SUMMARY OF INVENTION

### Technical Problem

However, in such a conventional power supply system, it is necessary to have an output voltage of an AC adapter or a PSU coincide with an input voltage of an electronic device, and for this purpose, in the case of using two or more electronic devices with different input voltages, it is necessary to use different AC adapters or PSUs adapted to the respective electronic devices. Accordingly, in supplying power to an electronic device from a commercial power source to use the electronic device, it is necessary to use a dedicated AC adapter or PSU for every electronic device in order to avoid unstable operation of the electronic device due to mismatch in DC input voltage.

Further, in recent years, use of natural renewable energy such as wind power, solar power, and the like, or a fuel cell has been encouraged, and accordingly, it is desired to use such power as a main power source or as an aid to a commercial power source. However, power generation utilizing natural renewable energy suffers from a problem that stable supply is insufficient, and a fuel cell has a problem that a fuel cell cannot readily follow a sharp change in power consumption of an electronic device. Furthermore, in using two or more power sources at the same time, it is necessary to switch the power sources so as not to interrupt power supply in order to ensure stable operation of an electronic device.

The present invention has been conceived in view of the above, and aims to provide a power supply system that does not require use of a dedicated AC adaptor for every input voltage value even when two or more electronic devices with different input voltages are used.

Additionally, the present invention aims to provide a power supply system capable of stable power supply to an electronic device even when using power utilizing natural renewable energy or a fuel cell, etc.

### Solution to Problem

In order to achieve the above described objects, the inventor of the present invention have focused on the LVDC (registered trademark in Japan) system, and conceived the present invention.

A power supply system according to the present invention is a power supply system to supply power from an external power source to an electronic device that operates at a predetermined DC voltage, including a wide-range DC/DC converter connected to the electronic device, to output, upon input of a DC voltage within a predetermined voltage range, a voltage at one or more kinds of fixed value/values irrespective of a value of the DC voltage inputted; and a supplied power stabilizing discharger connected to an output of the external power source and an input of the wide-range DC/DC converter, to discharge depending on a decrease of an output voltage of the external power source.

According to the present invention, it is desirable that the wide-range DC/DC converter is connected to a switching unit to selectively output anyone of output voltages of a plurality of external power sources, and that the discharger is connected to the switching unit and the wide-range DC/DC converter.

According to the present invention, it is desirable that the discharger discharges to thereby supply power to the wide-range DC/DC converter during a power supply suspended period from when the switching unit is disconnected from one of the external power sources to when the switching unit is connected with another of the external power sources.

According to the present invention, it is desirable that the electronic device includes a plurality of components that operate at respective different DC voltages.

According to the present invention, it is desirable that the discharger is a supplied power stabilizing charge/discharge unit for charging/discharging depending on an increase/decrease of an output voltage of the external power source.

According to the present invention, it is desirable that the charge/discharge unit includes an electric double layer capacitor.

According to the present invention, it is desirable that the charge/discharge unit includes a charging battery.

According to the present invention, it is desirable that the charge/discharge unit includes a primary battery.

According to the present invention, it is desirable that the DC voltage to be inputted into the wide-range DC/DC converter varies within a range equal to or lower than 60 V, which is a safety voltage.

### Advantageous Effects of Invention

According to a power supply system according to the present invention, as a charge/discharge unit for stabilizing supplied power|[ml] is connected to an input of a wide-range DC/DC converter, it is possible to ensure stable voltage output from the wide-range DC/DC converter even though the power supplied from an external power source varies due to various causes. As a result, according to the present invention, it is possible to supply power to two or more electronic devices with different operating voltages, using a single power supply system, which eliminates the need of using a dedicated adapter for every electronic device.

According to the present invention, it is possible to stabilize supplied power irrespective of the characteristics of the respective power sources (stability in power supply and followability to variation in power consumption of an electronic device) even when two or more power sources are used while being switched by a switching unit.

According to the present invention, it is possible to stably supply power to a wide-range DC/DC converter even during a power supply suspended period resulted in switching power sources by a switching unit.

According to the present invention, even when an electronic device includes a plurality of components that operate at different voltages, it is possible to stably supply power at respective voltages.

According to the present invention, use of an electric double layer capacitor, a charging battery, or the like, it is possible to eliminate the need of exchanging a discharger, to achieve sufficient stability of supplied power, and also to readily reduce the size of the system.

According to the present invention, as a charge/discharge unit is formed including a primary battery, an inexpensive power supply system can be implemented.

According to the present invention, as a charge/discharge unit is formed such that only a DC input voltage within a range equal to or lower than 60 V, or a safety voltage, is applied to the wide-range DC/DC converter, it is possible to avoid a situation in which a user or the like is exposed to a dangerous situation with a high voltage even when the inside of the electronic device is exposed.

### BRIEF DESCRIPTION OF DRAWINGS

FIG. 1 is a schematic diagram showing a power supply system according to a first embodiment of the present invention.

### DESCRIPTION OF EMBODIMENTS

In the following, embodiments of the present invention will be described.

### First Embodiment of the Present Invention

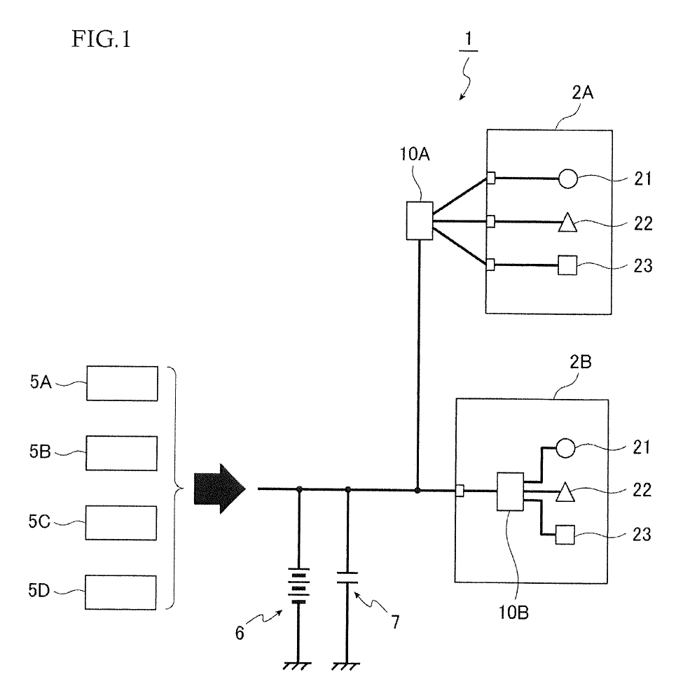

FIG. 1 shows a first embodiment of the present invention.

A power supply system 1 according to the first embodiment is formed so as to be adapted to the LVDC scheme. However, the present invention can be applied to a system other than a system based on the LVDC scheme.

As shown in FIG. 1, the power supply system 1 includes a charging battery (a secondary battery) 6 and a large-scale capacitor 7 as a charge/discharge unit according to the present invention. The charging battery 6 and the large-scale capacitor 7 are connected in parallel to each other and also each connected to four kinds of external power sources (that is, a first power source 5A, a second power source 5B, a third power source 5C, and a fourth power source 5D). The external power sources 5A to 5D supply power via wide-range DC/DC converters 10A, 10B to electronic devices 2A, 2B. Note that the wide-range DC/DC converter 10A is externally connected to the electronic device 2A, while the wide-range DC/DC converter 10B is incorporated in the electronic device 2B.

As the wide-range DC/DC converter 10A, for example, a DC/DC converter having a wide range input function, a digital power source having a wide range input function, or the like, can be used.

Meanwhile, as the wide-range DC/DC converter 10B, for example, a DC/DC converter having a wide range input function, a POL (Point of Load) converter having a wide range input function, a digital power source having a wide range input function, or the like, can be used.

Note here that a wide range input function refers to a function of outputting, upon input of a DC voltage in a predetermined wide range, a voltage at a single fixed value or two or more fixed values irrespective of the value of the input DC voltage. The first embodiment will be described referring as an example to a case in which the wide-range DC/DC converters 10A, 10B receive a DC voltage in the range equal to or lower than 60 V, or a safety voltage, and output three kinds of DC output voltages (for example, 3.3 V, 5 V, 12 V, or the like). However, the DC output voltage of each of the wide-range DC/DC converters 10A, 10B may be of a single kind.

As the wide-range DC/DC converters 10A, 10B, for example, GADIWA-3161, GADIWA-R9271, or the like, made by Portwell, Inc., can be employed.

Each of the electronic devices 2A, 2B includes three components 21, 22, 23 that operate at different DC voltages (for example, 3.3 V, 5 V, 12 V, or the like).

As described above, each of the wide-range DC/DC converters 10A, 10B has a function of receiving a DC voltage within a wide range equal to or lower than 60 V, or a safety voltage, and outputting a DC output voltage corresponding to the DC operating voltages of the electronic devices 2A, 2B to the respective electronic device 2A, 2B. With the above, both of the electronic devices 2A, 2B can operate at a voltage supplied by a single corresponding wide-range DC/DC converter 10A or 10B alone.

The first power source 5A is, for example, an AC/DC converter to output a DC converted from commercial AC power. The second power source 5B is, for example, a DC power source to output power generated utilizing natural renewable energy, such as wind power energy, solar power energy, solar thermal energy, etc. The third power source 5C is, for example, a DC power source to output power generated by a human power generator that is used at the time of disaster or the like. The fourth power source 5D is a fuel cell, for example. These external power sources 5A to 5D are connected to the wide-range DC/DC converters 10A, 10B of the power supply system 1 via a switching unit (not shown). That is, power outputted from any one of the external power sources 5A to 5D is selectively supplied to the wide-range DC/DC converters 10A, 10B. As described above, in the power supply system 1, a combination of power sources relying on different power generation principles can be employed as the combination of external power sources 5A to 5D.

Each of the charging battery 6 and the large-scale capacitor is a charge/discharge unit to store power supplied from the external power sources 5A to 5D, as described above. As shown in FIG. 1, each of the charging battery 6 and the large-scale capacitor 7 is connected at one terminal thereof to the input terminals of the respective wide-range DC/DC converters 10A, 10B, and grounded at the other terminal thereof.

As the charging battery 6, a charging battery of which output voltage at a fully charged state is within the range of an allowable input voltage (being equal to or lower than 60 V here) of the wide-range DC/DC converters 10A, 10B is used. For example, a lead-acid battery, a nickel-metal hydride battery, a lithium battery, a redox flow battery, etc., can be used. Note that in using the charging battery 6, it is desirable to use an external electronic circuit for turning on/off charging and turning on/off discharging.

Meanwhile, as the large-scale capacitor 7, an electric double layer capacitor, for example, is used. It is desirable that the capacitance of the large-scale capacitor 7 is equal to or larger than 1 farad, for example, in the case where the electronic devices 2A, 2B are typical ICT devices.

Note that although the charging battery 6 and the large-scale capacitor 7 are both used here as a charge/discharge unit in the above, only one of the charging battery 6 and the large-scale capacitor 7 may be used. Alternatively, a different kind of charge/discharge unit may be usable as well.

The charging battery 6 and the large-scale capacitor 7 are charged, using a current supplied from the external power sources 5A to 5D, and discharge when an output voltage of the external power sources 5A to 5D is decreased. With the above, the charging battery 6 and the large-scale capacitor 7 reduces variation in the input voltage of the wide-range DC/DC converters 10A, 10B.

For example, as to the power sources 5B, 5C utilizing natural renewable energy or human power generation, there is a case in which supplied power may temporarily decrease (for a few to a few tens of seconds, for example). In such a case, according to the first embodiment, the charging battery 6 and the large-scale capacitor 7 charge/discharge, depending on an increase/decrease of the input voltage. As a result, it is possible to reduce variation in supplied power.

In switching connection of an external power source connected to the power supply system 1 from any one to another of the power sources 5A to 5D, there is a possibility that power supply to the power supply system 1 will be temporarily suspended (for about one second, for example). According to the power supply system 1, in such a case as well, as the charging battery 6 and the large-scale capacitor 7 discharge, it is possible to prevent suspension of power supply to the wide-range DC/DC converters 10A, 10B.

Further, there is a case in which power consumption of the electronic devices 2A, 2B temporarily increases sharply for some reason. In such a case, supplied power from an external power source (any of the power supplies 5A to 5D) connected to the power supply system 1 may not be able to follow such an increase of the power consumption. In particular, an output of the fuel cell 5D is slow to follow in such a case, which may hinder stable supply of sufficient power to the electronic devices 2A, 2B. According to the power supply system 1, even in such a case as well, it is possible to maintain supply of sufficient power as it is possible to change the amount of discharge by the charging battery 6 and the large-scale capacitor 7 so as to follow an increase of power consumption of the electronic devices 2A, 2B.

As describe above, according to this power supply system 1, even in the cases where power from wind power generation, solar power generation, or the like, is used, where an external power source in use is switched, and where power consumption of the electronic devices 2A, 2B sharply increases, and the like, it is possible to stably supply power to the wide-range DC/DC converters 10A, 10B, using the charging battery 6 and the large-scale capacitor 7.

Therefore, in supplying power to the electronic devices 2A, 2B, the wide-range DC/DC converters 10A, 10B can apply a stable voltage to the respective components 21, 22, 23 of these electronic devices 2A, 2B. Accordingly, the power supply system 1 can ensure stable operation of the electronic devices 2A, 2B even when an input voltage from the external power sources 5A to 5D is not stable.

As a result, according to the power supply system 1, it is possible to stably apply a voltage to the electronic devices 2A, 2B, using the wide-range DC/DC converters 10A, 10B. Accordingly, according to the power supply system 1, it is unnecessary to use a dedicated AD adapter for every electronic device depending on the kind of the external power sources 5A to 5D.

Moreover, according to the power supply system 1, as the wide-range DC/DC converters 10A, 10B receive only a DC voltage within a range equal to or lower than 60 V, or a safety voltage, it is possible to avoid a situation in which a user or the like of the electronic devices 2A, 2B is exposed to a dangerous situation with a high voltage even when the inside of the electronic device 2A, 2B is exposed. This can improve safety of the power supply system 1 at the time of use.

Further, according to the power supply system 1, the wide range input function of the wide-range DC/DC converters 10A, 10B makes it possible to use a charging battery 6, the output voltage of which is different from a voltage originally needed. For example, the electronic devices 2A, 2B that require an input voltage at about 19 V can be made to operate, using a charging battery 6 at about 12 V.

Additionally, as the power supply system 1 has the wide-range DC/DC converters 10A, 10B, the charging battery 6, and the large-scale capacitor 7, it is possible to achieve stable power supply even when an external power source (in particular, the power sources 5B, 5C utilizing natural renewable energy or human power generation) does not have a device for stabilizing supplied power.

### Other Embodiments of the Present Invention

In the above described first embodiment, the power supply system 1 for supplying power from four kinds of external power sources 5A to 5D to the electronic devices 2A, 2B has been described. However, the external power sources 5A to 5D for supplying power to the electronic devices 2A, 2B are not limited to these four kinds, and a primary battery, such as a dry battery, for example, can be used. In the case where a primary battery is used as an external power source, there is an advantage that the electronic devices 2A, 2B can be kept operating even if the voltage of the primary battery in use decreases as the wide-range DC/DC converters 10A, 10B input a DC voltage in a wide range.

Further, although the charging battery 6 and the large-scale capacitor 7 are used as a charge/discharge unit in the above described first embodiment, other types of charge/discharge units may be used instead of or in addition to the charging battery 6 and the large-scale capacitor 7 as long as it is possible to store electricity supplied from an external power source.

Furthermore, a primary battery, such as a dry battery, or the like, may be used instead of the charging battery 6. That is, instead of the charge/discharge unit (a combination of the charging battery 6 and the large-scale capacitor 7) in the first embodiment, a combination of a primary battery and the large-scale capacitor 7 may be used, or a primary battery alone may be used without using a charge/discharge unit. For example, in the case where a power source with very little variation in supplied power, like a commercial power source, is mainly used, it is possible to achieve sufficient stability, using a dry battery alone. Use of a primary battery can eliminate the need of a circuit for turning on/off charging, and can reduce the cost of the battery itself and thus the cost of the power supply system as a whole.

### INDUSTRIAL APPLICABILITY

According to the present invention, it is possible to cause electronic devices that operate at various DC voltages to operate, using a single dry battery alone, for example, which is very useful.

### REFERENCE SIGNS LIST

1 power supply system
2A, 2B electronic device
3 commercial power source
4 AC adapter
5A, 5B, 5C, 5D external power source
6 battery (charge/discharge unit)
7 large-scale capacitor (charge/discharge unit)
10A, 10B wide-range DC/DC converter
21, 22, 23 component

1. A power supply system to supply power from an external power source to an electronic device that operates at a predetermined DC voltage, comprising:
a wide-range DC/DC converter connected to the electronic device, to output, upon input of a DC voltage within a predetermined voltage range, a voltage at one or more kinds of fixed value/values irrespective of a value of the DC voltage inputted; and
a supplied power stabilizing discharger connected to an output of the external power source and an input of the wide-range DC/DC converter, to discharge depending on a decrease of an output voltage of the external power source.

2. The power supply system according to claim 1, wherein
the wide-range DC/DC converter is connected to a switching unit to selectively output any one of output voltages of a plurality of the external power sources, and
the discharger is connected to the switching unit and the wide-range DC/DC converter.

3. The power supply system according to claim 2, wherein the discharger discharges to thereby supply power to the wide-range DC/DC converter during a power supply suspended period from when the switching unit is disconnected from one of the external power sources to when the switching unit is connected with another of the external power sources.

4. The power supply system according to claim 1, wherein the electronic device includes a plurality of components that operate at respective different DC voltages.

5. The power supply system according to claim 1, wherein the discharger is a supplied power stabilizing charge/discharge unit for charging/discharging depending on an increase/decrease of an output voltage of the external power source.

6. The power supply system according to claim 5, wherein the charge/discharge unit includes an electric double layer capacitor.

7. The power supply system according to claim 5, wherein the charge/discharge unit includes a charging battery.

8. The power supply system according to claim 5, wherein the charge/discharge unit includes a primary battery.

9. The power supply system according to claim 1, wherein the DC voltage to be inputted into the wide-range DC/DC converter varies within a range equal to or lower than 60 V, which is a safety voltage.
